(19) United States
(12) Patent Application Publication
(10) Pub. No.: US 2025/0377045 A1
(43) Pub. Date: Dec. 11, 2025

(54) MEDIA CONDUCTING ELEMENT AND DISTRIBUTION SYSTEM FOR TRANSPORTING MEDIA

(71) Applicant: TI Automotive Technology Center GmbH, Rastatt (DE)

(72) Inventors: Irfan KIZILAY, Reilingen (DE); Manuel LINDOW, Gernsbach (DE); Stefan LEIPOLD, Seltz (FR)

(21) Appl. No.: 19/229,751

(22) Filed: Jun. 5, 2025

(30) Foreign Application Priority Data
Jun. 5, 2024 (EP) 24180284.2

(51) Int. Cl. F16K 11/087

(52) U.S. Cl. CPC F16K 11/0873

(57) ABSTRACT

A media conducting element, comprising a housing which delimits a volume, wherein at least two fluid openings are introduced into the housing, wherein the fluid openings are each connected to a fluid line, wherein the volume interacts with the fluid openings, wherein the housing is surrounded on the outside, at least in sections, by a casing, wherein the housing and the casing delimit a throughflow volume, wherein at least two fluid connections introduced into the casing open into the throughflow volume, as well as a distribution system for transporting media.

### RELATED APPLICATIONS

The present disclosure claims priority to and the benefit of European Application 24180284.2, filed on Jun. 5, 2024, the entire contents of each of which are incorporated herein by reference.

### FIELD

The present disclosure relates to a media conducting element, comprising a housing which delimits a volume, wherein at least two fluid openings are introduced into the housing, wherein the fluid openings are each connected to a fluid line, wherein the volume interacts with the fluid openings, wherein the housing is surrounded on the outside, at least in sections, by a casing, as well as a distribution system for transporting media.

### BACKGROUND

Such a media conducting element in form of a valve is known, for example, from EP 4 008 935 A1. Valves are often used in cooling circuits to control the coolant flow. A cooling fluid can flow in and out of the valve through the fluid openings that are introduced into the valve housing. The valve body is provided with a channel structure and controls the coolant flow, wherein, depending on the embodiment and number of fluid openings, different cooling circuits can be controlled, the volume flow regulated or the flow direction adjusted.

Such valves are often used in temperature control circuits in the field of electromobility. In order to achieve a high range for electric vehicles, it is necessary, in most cases, to control the temperature of electrical components. The components whose temperature needs to be controlled are, in particular, batteries, but also the power electronics or plug connections of fast-charging devices. A battery has a best possible capacity only in a very small temperature spectrum. Therefore, it is necessary to heat batteries of electric vehicles at low ambient temperatures and to cool them at high outside temperatures or at load demand.

For this purpose, it is known to provide a temperature control circuit through which a temperature control medium flows. Depending on the requirements, the temperature control medium can either be heated in a heating device or cooled in a cooling device. The temperature control medium flow can be controlled by one or more valves of the type mentioned above.

In electric vehicles in particular, the available installation space is limited, and the distribution of the temperature control medium should therefore be performed via an integrated distribution system wherever possible. Said distribution systems contain multiple channels and functional elements through which temperature control media can be conducted and directed to the components that need to be temperature-controlled. Depending on the arrangement of the components, it can be necessary for channels to cross over each other without the media flows mixing, which is usually associated with an increased installation space requirement and an increased number of components.

### BRIEF SUMMARY

The present disclosure provides a media conducting element which enables complex fluid guides with simple means and low installation space requirements.

A media conducting element preferably comprises a housing which delimits a volume, wherein at least two fluid openings are introduced into the housing, wherein the fluid openings are each connected to a fluid line, wherein the volume interacts with the fluid openings, wherein the housing is surrounded on the outside, at least in sections, by a casing, wherein the housing and the casing delimit a throughflow volume, wherein at least two fluid connections introduced into the casing open into the throughflow volume.

The medium conducted in the fluid lines is not in flow-conducting contact with the casing, so that medium that is present in the throughflow volume cannot enter the fluid lines and vice versa. The throughflow volume provides a volume allocated to the media conducting element that allows the receiving, storing or passing-through of medium, wherein the medium flows in and out of the casing via the fluid connections. This allows a medium to cross the media conducting element without being influenced by the control elements of the media conducting element, for example a valve body. The medium conducted into the housing through the fluid lines, on the other hand, is conducted into the volume and discharged from the volume without coming into contact with the medium conducted through the casing. The throughflow volume provides a bypass through which fluid can cross the media conducting element independently of the medium flowing in and out of the volume. The volume and the throughflow volume are separated from each other in a media-tight manner and the media conducted through the volume and the throughflow volume can be influenced independently of each other.

The media conducting element can be formed as a pump, pipe crossing or vessel, in particular as an expansion vessel.

The media conducting element can be formed as a valve, wherein a valve body is accommodated in the volume, wherein the valve body interacts with the fluid openings. The throughflow volume provides a volume allocated to the valve that allows medium to flow through, this medium flowing in and out of the casing via the fluid connections. This allows a medium to cross the valve without being influenced by the control elements of the valve, for example the valve core. The medium conducted through the fluid lines into the valve housing, on the other hand, is influenced by the valve core, so that the quantity and direction of flow of the medium conducted in the fluid lines can be modified as a result.

The housing, the valve body and/or the casing can be formed of plastic. Preferably, a thermoplastic material is used. This means that the media conducting element can be produced in a cost-effective manner. Preferred materials for the housing, the valve body and the casing are selected, for example, from the group of polyoxymethylenes (POM), polyphenylene sulphides (PPS), polypropylene (PP) or polyamides (PA). Thermoplastic elastomers such as thermoplastic vulcanizates (TPV) or thermoplastic olefins (TPO) can also be used. The plastics can be provided with additives, for example a fiber reinforcement or a conductivity finish based on glass fibers or additives to increase conductivity.

Further, it is conceivable that the housing is formed as a composite element made of at least two materials. For example, the housing body of the housing can be formed of plastic and a connecting element of the housing can be formed of a metallic material. The use of a plastic compound is also conceivable, wherein in particular materials adapted to the connection interfaces can be selected.

The casing can be formed as a multi-layered composite. The casing can comprise adhesion promoter layers and/or foamed layers.

The housing and/or the casing can be formed as a blow-molded part. The manufacture of the valve housing and casing using the blow molding process allows for a cost-effective manufacture of the valve housing and casing, wherein the embodiment of a complex geometry is possible in each case. Alternatively, the housing and/or the casing can be formed as an injection-molded part in a cost-effective manner. The valve body is preferably formed as an injection-molded part.

The valve can be formed as a check valve or as a switching valve. In particular, the valve can be formed as a rotary valve, wherein the valve body is rotatably arranged in the valve housing. With a rotary valve, the media flow conducted through the fluid lines is adjusted by rotating the valve body, wherein the corresponding actuator for rotating the valve body is formed in a simple manner and is easily controllable. Accordingly, rotary valves and the associated actuators can be manufactured in a cost-effective manner. Another advantage is that a rotary valve can influence the media flow in a plurality of fluid lines simultaneously and requires only little installation space. It is also conceivable that the valve is formed as a check valve.

The casing can form a section of a distribution system. The distribution system comprises several integrated fluid lines via which the medium is conducted to components that are connected to the distribution system. The distribution system is particularly compact and only requires little installation space. Due to the fact that the casing forms a section of the distribution system, the media conducting element is integrated into the distribution system, which allows for a particularly compact embodiment.

The housing can be accommodated in the casing. In this embodiment, the housing is completely surrounded by the casing. If the media conducting element is a valve, the valve body arranged in the housing is also surrounded by the casing. In case of a rotary valve, only the switching shaft protrudes through the casing, the switching shaft being used to control the rotation of the valve body. This results in an integrated embodiment with particularly low installation space requirements. It is conceivable that the housing consists of several parts, in particular two parts, wherein a base body along with the casing and the fluid openings forms a mounting support for the valve body and, if applicable, the actuator of the valve body.

The throughflow volume can be allocated to one side of the housing. In this embodiment, the housing can, for example, cover a valve body on one side, for example on the end face side, and the casing in turn covers the housing while enclosing the throughflow volume. In this embodiment, the throughflow volume is separated from the volume in a media-tight manner. This embodiment can be produced cost-effectively.

The throughflow volume can surround the housing in an annular manner. The medium flowing through the throughflow volume can flow around the outside of the housing, resulting in a particularly low installation space requirement, especially with regard to the required installation height. In this embodiment, no fluid lines penetrate the throughflow volume and the medium flowing through the fluid lines is not exchanged with the throughflow volume. In this respect, the throughflow volume is separated from the volume in a media-tight manner in this embodiment.

The fluid lines penetrating the casing can be formed as connecting pieces. In case of fluid lines formed as connecting pieces, the fluid lines and the housing can be formed as one piece. This means that the housing and the channels connected to it can be produced in one go, for example using the blow molding process.

In order to manufacture the media conducting element, the housing with the fluid lines in form of connecting pieces can be inserted into a blow mold, wherein a preform is then placed over the housing, wherein the casing is formed from the preform. In particular, a distribution system can also be formed using the blow molding process and preferably multiple channels are arranged in the distribution system, wherein the blow mold is formed in such a way that the fluid lines that open into the housing are connected to channels of the distribution system in a flow-conducting manner after blow molding. In doing so, the fluid lines penetrate the casing, so that the media in the fluid lines and in the casing cannot mix. Overall, this allows manufacturing a compact and integrative component.

A distribution system according to the present disclosure for transporting media comprises a base body in which multiple channels are formed, wherein at least one media conducting element according to the present disclosure is accommodated in the base body, wherein first channels are connected to the fluid lines and second channels are connected to the fluid connections.

Via the distribution system, medium can be conducted to components connected to the distribution system. Said components can be, for example, batteries, power electronics, but also heat exchangers for heating the vehicle interiors of automobiles. The medium conducted through the first channels enters the media conducting element and flows into the volume via the housing, where it can be influenced. In case of the embodiment as a valve, both the volume flow and the direction of flow of the medium conducted through the first channels can be influenced. The medium conducted through the second channels flows into the casing via the fluid connections and is not influenced by the media conducting element. The medium flows through the throughflow volume, which is delimited by the casing. This allows the medium conducted through the second channels to cross the valve without being influenced by the valve core. The distribution system can comprise at least one media conducting element in form of a valve, wherein the distribution system can in particular also comprise multiple valves that are integrated into the distribution system.

The distribution system can also comprise other media conducting elements, such as expansion vessels, pumps, feed pumps and/or sensors. Furthermore, the distribution system can comprise holding structures and the like. In doing so, the distribution system forms an integrated component which, in addition to the flow line, has further functionalities by which the medium flowing through the distribution system can be influenced or by which the status parameters of the medium can be recorded. When the distribution system is used to distribute temperature control medium, the distribution system can also be referred to as a coolant distributor.

The base body is preferably manufactured by blow molding using the blow molding process described above. Due to the blow molding, the channels can be molded directly into the base body. Accordingly, the base body is preferably formed as a blow-molded part and the base body can also form the casing. The channels and the casing are formed in one piece from the base body.

### BRIEF DESCRIPTION OF THE DRAWINGS

Some embodiments of the media conducting element according to the present disclosure and the distribution system according to the present disclosure are described in more detail below with reference to the figures. These show, each schematically:

FIG. 1 a distribution system for transporting media in top view;

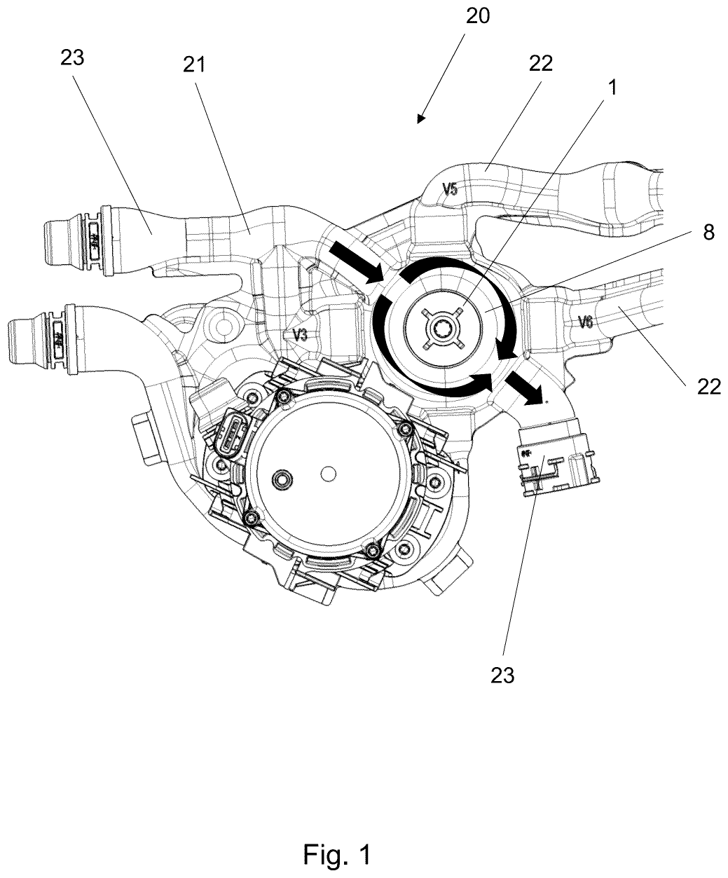

FIG. 2 the distribution system with integrated media conducting element in section.

### DETAILED DESCRIPTION

The figures show a distribution system 20 for transporting media, which is used in a temperature control circuit of an electric vehicle. Temperature control media can be distributed via the distribution system 20 and conducted to the devices to be temperature-controlled, for example the batteries, the electric motors, the power electronics or the heat exchangers of the passenger compartment temperature control system.

The distribution system 20 comprises a base body 21 in which multiple channels 22, 23 are formed here as an example. A media conducting element 1 in form of a rotary valve is accommodated in the base body 21. The base body 21 is formed as a blow-molded part and is made of polypropylene (PP) in this embodiment.

The media conducting element 1 integrated into the distribution system 20 comprises a housing 2 which delimits a volume 3, wherein a valve body 12 is accommodated in the volume 3. Due to the embodiment as a rotary valve, the valve body 12 is arranged rotatably in the housing 2. Multiple fluid openings 4, 5 are introduced into the housing 2, wherein the fluid openings are each connected to a fluid line 6, 7. The valve body 12 interacts with the fluid openings 4, 5.

The housing 2 is surrounded on the outside by a casing 8, wherein the casing 8 is formed in such a way that the housing 2 and the casing 8 delimit a throughflow volume 9. The fluid lines 6, 7 penetrate the throughflow volume 9, so that the medium conducted through the fluid lines 6, 7 cannot enter the throughflow volume 9.

Two fluid connections 10, 11 introduced into the casing 8 open into the throughflow volume 9.

The housing 2 and the valve body 12 are formed of plastic. In this embodiment, the housing 2 is formed of a composite of polyamide (PA) and glass fiber-reinforced polypropylene (PP-GF) and the valve body 12 is formed of a composite material comprising ceramic, metal and plastic. In this case, the valve body 12 is manufactured partly by injection molding and the casing 8 by blow molding. Alternatively, the casing 8 can also be manufactured by injection molding.

The casing 8, in which the housing 2 with valve body 12 is accommodated, is a component of the distribution system 20, wherein the casing 8 is formed from the base body 21.

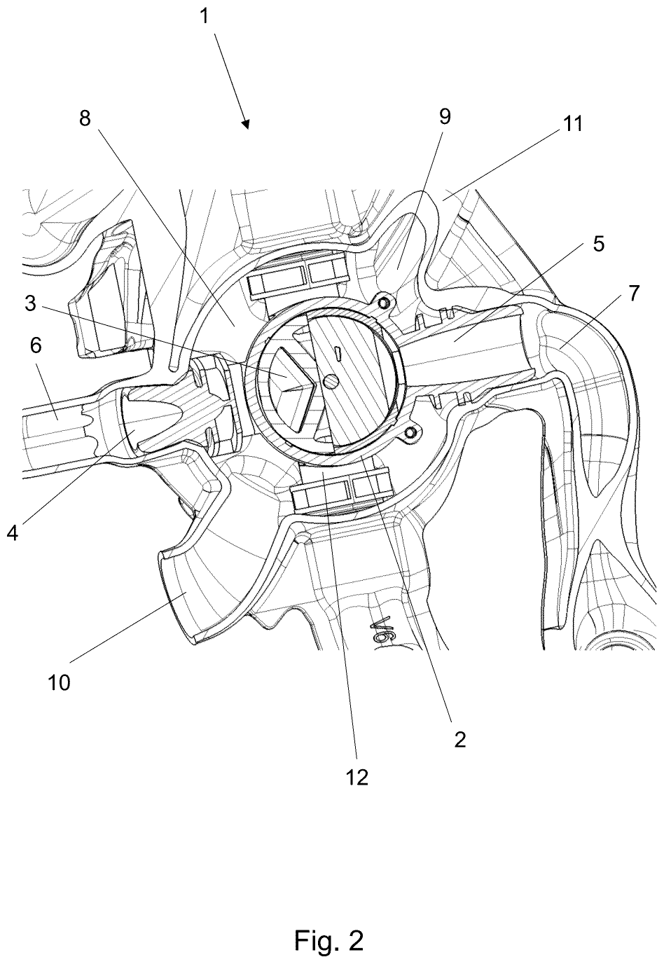

In the embodiment shown in FIG. 2, the throughflow volume 9 is allocated to an end face of the valve body 12. The housing 2 covers the volume 3 and the valve body 12 on the side of the end face and the casing 8 in turn covers the housing 2 while enclosing the throughflow volume 9.

In an alternative embodiment or in addition to the end face side arrangement, the throughflow volume 9 can surround the housing 2 in an annular manner. The medium flowing through the throughflow volume 9 can flow around the outside of the housing 2, wherein the fluid lines 6, 7 penetrate the casing 8, so that the media from the fluid lines 6, 7 and from the casing 8 do not mix there.

The fluid lines 6, 7 penetrating the casing 8 are formed as connecting pieces and are manufactured in one piece with the housing 2 using the blow molding process.

Multiple channels 22, 23 are formed in the base body 21, wherein first channels 22 are connected to the fluid lines 6, 7 and second channels 23 are connected to the fluid connections 10, 11. The base body 21 forms the casing 8.

In order to manufacture the distribution system 20, a media conducting element 1 with housing 2 and the fluid lines 6, 7 formed as connecting pieces is inserted into a blow mold. A preform is then placed over the valve housing 2, wherein base body 21 of the distribution system 20 along with the casing 8 is formed from the preform. The base body 21 is formed in such a way that multiple channels 22, 23 are arranged in the distribution system 20 in an exemplary manner in this exemplary embodiment. The blow mold is further formed in such a way that the fluid lines 6, 7 which open into the housing 2 are connected to channels 22 of the distribution system 20 in a flow-conducting manner after blow molding.

1. A media conducting element, comprising a housing which delimits a volume, wherein at least two fluid openings are introduced into the housing, wherein the fluid openings are each connected to a fluid line, wherein the volume interacts with the fluid openings, wherein the housing is surrounded on the outside, at least in sections, by a casing, and wherein the housing and the casing delimit a throughflow volume, wherein at least two fluid connections introduced into the casing open into the throughflow volume.

2. The media conducting element according to claim 1, wherein a valve body is accommodated in the volume, wherein the valve body interacts with the fluid openings.

3. The media conducting element according to claim 1, wherein the housing, the valve body and/or the casing are formed of plastic.

4. The media conducting element according to claim 1, wherein the housing and/or the casing are formed as a blow-molded part.

5. The media conducting element according to claim 2, wherein the valve is formed as a switching valve or as a check valve.

6. The media conducting element according to claim 2, wherein the media conducting element is formed as a rotary valve, wherein the valve body is arranged rotatably in the valve housing.

7. The media conducting element according to claim 1, wherein the casing forms a section of a distribution system.

8. The media conducting element according to claim 1, wherein the housing is accommodated in the casing.

9. The media conducting element according to claim 1, wherein the throughflow volume is allocated to one side of the housing and is separated from the volume in a media-tight manner.

10. The media conducting element according to claim 1, wherein the throughflow volume surrounds the housing in an annular manner and is separated from the volume in a media-tight manner.

11. The media conducting element according to claim 1, wherein the fluid lines penetrating the casing are formed as connecting pieces.

12. The media conducting element according to claim 1, wherein the fluid lines and the housing are formed as one-piece.

13. A distribution system for transporting media, comprising a base body in which multiple channels are formed, wherein at least one media conducting element according to claim 1 is accommodated in the base body, wherein first channels are connected to the fluid lines and second channels are connected to the fluid connections.

14. The distribution system according to claim 13, wherein the base body is formed as a blow-molded part or injection-molded part.

15. The distribution system according to claim 13, wherein the base body forms the casing.
